(19) United States
(12) Patent Application Publication
(10) Pub. No.: US 2006/0139003 A1
(43) Pub. Date: Jun. 29, 2006

(54) Self-labeling energy storage units

(76) Inventors: Addison M. Fischer, Naples, FL (US); Randal J. Martin, Naples, FL (US)

Correspondence Address: NIXON & VANDERHYE, PC, 901 NORTH GLEBE ROAD, 11TH FLOOR, ARLINGTON, VA, 22203, US

(21) Appl. No.: 11/078,698

(22) Filed: Mar. 14, 2005

Related U.S. Application Data
(60) Provisional application No. 60/638,238, filed on Dec. 23, 2004.

(51) Int. Cl. H02J 7/00

(52) U.S. Cl. 320/132

(57) ABSTRACT

A small micro-controller with other associated circuitry is embedded in the housing of a battery to digitally display a battery's state on its exterior. The measurements computed or displayed can include indications of any state of the battery including, but without limitation, indications of (1) the amount of time remaining until the battery's current charge is exhausted, (2) the amount of power remaining in the battery (3) including for example a percentage remaining, (4) the amount of time until the battery will no longer accept a charge, (5) the amount of shelf life remaining (6) the amount of shelf life remaining until the battery charge depletes to a certain threshold and (7) the current voltage being delivered (8) the amperage available.

### CROSS-REFERENCES TO RELATED APPLICATIONS

This application claims the benefit of Provisional Application No. 60/638,238, filed Dec. 23, 2004, the entire content of which is hereby incorporated by reference in this application.

### FIELD OF THE INVENTION

This invention generally relates to energy storage devices. More particularly, the invention relates to energy storage device-related methods and apparatus for uniquely displaying information about the state of energy storage devices, such as batteries.

### BACKGROUND AND SUMMARY OF THE INVENTION

With the continued rise of portable devices especially micro-electronic devices including for example computers, cameras, media players, PDAs (personal digital assistants), telephones, pagers, but also including, for example, flashlights, radios, etc, there is a continued need for batteries and other power storage devices. In many cases, rechargeable batteries, including for example technologies such as Nickel-Cadmium (Ni-Cad), Nickel Metal Hydride (NiMH), Lithium-ion (L-ion), etc are used.

In some cases, devices employ custom designed batteries. In other cases, the devices use commonly available batteries in form factors such as, for example, AA, AAA, 9-volt, CR-123, etc. In some instances, especially where the batteries are built-in to the device (and are not removable), the device has a means for displaying the amount of power or charge remaining in the battery. This is also sometimes true for devices in which the battery is removable. An Uninterruptible Power Supply (UPS) is an example of a device where it is important to know the status of the battery while it remains in place in a device. Too often a UPS battery has deteriorated beyond a useful condition, however the battery state is not known until the power fails and the UPS battery is unable to provide the necessary backup.

Especially in situations where standardized rechargeable batteries (e.g., AA, etc) are used, it can be confusing to know which batteries contain a charge and how much. Devices that measure battery charge exist, and if these are available, they can be used to determine a battery's state.

However, on occasions when such measuring devices are not available, or when such devices do not apply to specialized batteries (e.g., for digital cameras with custom batteries), one may take multiple batteries on an excursion, and after a few days, it can become confusing as to which batteries are charged and which are not fully charged.

Examples of equipment with customized or limited-availability energy storage devices include for example (and without limitation): digital cameras, video cameras, media recorders, media players, cellular telephones, portable phones, computers, computer peripherals, broadcast players, broadcast recorders, and equipment for illumination, data memory, data storage, location sensing, communication, medical, display, defense, vehicles, households, backup power, security systems and personal use.

The illustrative embodiments include unique apparatus and methodology for equipping batteries with additional technology to measure the state of the battery and displaying it on the battery's exterior. While there are already some technologies that work toward a similar goal, the illustrative embodiments exemplify unique, easier to use and interpret methods and apparatus for accomplishing this end.

Existing means for self-measuring batteries, include, e.g., the Duracell PowerCheck on-battery Tester present on some of their non-rechargeable batteries. This consists of a voltage-sensitive chemical embedded in the battery's packaging wrapper. By squeezing the wrapper properly, contact is made with the battery's “+” and “−” terminals, and the voltage causes the electro-sensitive chemical strip to change color. The degree of color change can be used as a rough indicator of the battery's remaining energy.

The illustrative embodiments described herein operate digitally, and employ a small micro-controller embedded in the housing of the battery to digitally display a battery's state on its exterior. There are many possible variations of this embodiment, depending on factors such as, for example: the power required by the micro-controller, the type and technology of the exterior display, the power capacity of the battery, and the expected shelf-life of the charge. The measurements computed or displayed can include indications of any state of the battery including, but without limitation, indications of (1) the amount of time remaining until the battery's current charge is exhausted, (2) the amount of power remaining in the battery (3) including for example a percentage remaining, (4) the amount of time until the battery will no longer accept a charge, (5) the amount of shelf life remaining (6) the amount of shelf life remaining until the battery charge depletes to a certain threshold (7) the current voltage being delivered (8) the amperage available (9) any other characteristic relevant to a particular implementation.

### BRIEF DESCRIPTION OF THE DRAWINGS

FIG. 1 is an illustrative embodiment of a battery that has been enhanced to include a non-volatile display.

FIG. 2 is an exemplary embodiment of a switched self-labeling storage device system.

FIG. 3 is an exemplary block diagram of a self-labeling energy storage system such as the one illustrated in FIG. 1.

FIG. 4 illustrates the discharge characteristics for an Eveready No. NH15 NiMH battery which is rated at an average capacity of 1850 mAh down to 1.0 volts.

FIG. 5 is an illustration similar to FIG. 4 for the Duracell Ultra MX1500 AA Alkaline-Manganese Dioxide Battery (Alkaline).

FIG. 6 and FIG. 7 are illustrative graphs of available battery energy capacity derived from FIG. 4 Eveready No. NH15 NiMH and FIG. 5 Duracell Ultra MX1500 Alkaline-Manganese respectively.

FIG. 8 is an illustrative block diagram of a further exemplary embodiment.

### DETAILED DESCRIPTION OF THE EXEMPLARY EMBODIMENTS

A first illustrative embodiment is especially applicable, for example, for (rechargeable) AA NiMH (so-called Nickel-Metal Hydride) batteries. In this case, the NiMH technology provides for storing a relativity large amount of energy which it can supply to electronics such as digital cameras. However the chemistry loses charge rapidly compared with, say, alkaline or Li-ion (“Lithium Ion”) chemistries. So the shelf-life of a charge is relatively short. Depending in large part on the storage temperature, these batteries often lose charge at the rate of as much as 1% to 5% per day. In this case, the minor drain of a low-power, though constantly running, micro-controller, may not significantly affect the battery's overall charge shelf-life.

Therefore one illustrative, economical embodiment consists of a small micro-controller and other miniature electronics embedded in the battery's housing. It is constantly coupled to the battery's power, drawing a minute amount of current to operate while it occasionally measures the existing voltage and power characteristics. In one such exemplarity embodiment, only a small charge must be constantly siphoned away to drive an oscillator/counter. Only occasionally, say on the order of hours or days, when this counter overflows, are the more complicated, and power-consuming, aspect of electronics activated and powered up. When this happens, the micro-controller and its associated other electronics assesses various parameters of the battery—including for example, the level of voltage, the amount of current flowing—to estimate the amount of power remaining in the cell.

In a more elaborate implementation, which again depends on the size, applicability, power consumption and costs of the components, and deemed importance of accuracy, embodiments may also contain memory to record a history of the battery's past states over time, which can be also used in the calculation of the energy, power and availability estimates. In some exemplary implementations such memory may be implemented as “RAM” (or other memory requiring a small trickle of constant power to retain information). In other illustrative embodiments; a non-volatile, stable memory, such as for example, “flash” memory, which holds information without requiring constant power may be used. It is anticipated that in the future non-volatile memory technologies will become cost effective to use and are contemplated for use in exemplary implementations. These include, for example, Magnetic RAM (MRAM) under development by IBM Corporation, Intel Corporation and others. Depending on the chemistry of the battery, and the availability, cost, and applicability, sensors measuring other aspects of the battery may also be used—these might include, for example, and without limitation, those which may measure the level of acidity, voltage, amperage, impedance, resistance, temperature, or other indicators of the battery's capability and history.

After measurements and estimates of the battery's characteristics are made, they are then displayed for a user's eventual comprehension. Once again, implementation of the display used by this embodiment depends on the comparative characteristics, cost, market feasibility, and availability of each particular technology. Those which are discussed herein are not intended to be either exhaustive or limiting, but merely exemplary depending on different constraints. Measurement techniques are expected to vary with the type of battery and its chemistry. For example, in many NiMH batteries, voltage level is not a good predictor of remaining battery life. These batteries maintain a relatively constant voltage level over the life of a charge. Whereas, some alkaline batteries show a much more pronounced change in voltage as the batteries useful energy is depleted.

In accordance with an exemplary embodiment, one type of display technology that may be used is “conventional” Liquid Crystal Display (LCD) technology which has been available, in various states of refinement, for many years. One version, often seen and employed on low cost hand-held calculators, on desk telephones, etc, is the black crystal on light background, where visibility is due to ambient lighting rather than back-lighting. This requires only a very small constant charge to hold the display state.

Other types of displays which are contemplated for use in an exemplary embodiment include displays not requiring continuous power to hold an image once it is displayed. Some examples are the Gyricon technology, from Gyricon LLC which was developed at Xerox PARC, and the e-ink technology from E Ink Corporation and manufactured by Royal Philips Electronics and others. For example, the e-ink technology is used in the Sony Librie EBP-1000 e-Book. There are also bistable LCD technologies that provide persistent displays after the power has been removed, such as the Cholesteric LCD which was developed with the help of Kent State University and marketed by Kent Display Systems. Additionally, Zenithal Bistable display technology (ZBD), developed by ZDB Displays, provides a second persistent LCD technology. All of these technologies offer extremely low power consumption and the ability for the image to persist after the power is removed. This technology offers significant advantages as a digital label when used with the embodiments described herein.

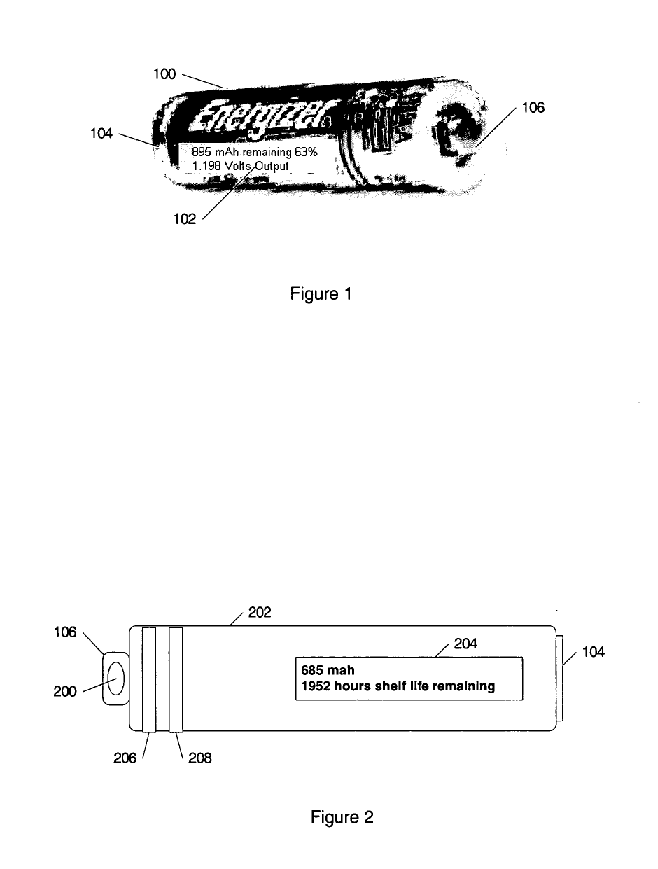

FIG. 1, in accordance with a first illustrative embodiment, illustrates an Eveready™ Energizer AA NiMH battery 100 that has been enhanced to include a non-volatile display 102. This label illustratively displays the current state of the battery. For example, as shown in the illustration, this battery has 895 milli-amp hours (mAh) of power remaining from its original 1420. This represents 63% of it original power. The present available voltage of the device is 1.198 volts. These values are illustratively arrived at by monitoring the usage of the present device and calculated by the method described below.

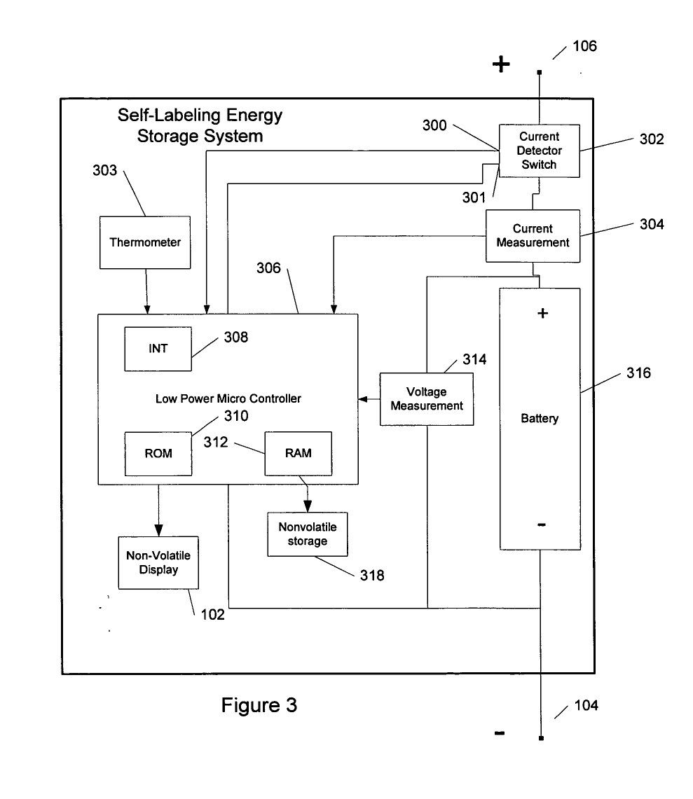

FIG. 3 is a block diagram of an exemplary self-labeling energy storage system for generating a display such as the one illustrated in FIG. 1. It contains a positive terminal 106, a negative terminal 104, and a non-volatile display 102 such as a Zenithal Bistable display. Such a display only requires power when it is being updated. Otherwise no power is required to maintain the contents of the display. Power is provided to terminals 106 and 104 by for example NiMH battery 316. Other battery types are contemplated including but not limited to alkaline, lead-acid, silver oxide, lithium-ion, Nickel Cadmium and other conventional energy storage devices. A wide range of other non-conventional energy storage systems are also further contemplated. It is further anticipated that new battery technologies will continue in the future and such technologies are also contemplated for use in an exemplary embodiment.

In this exemplary embodiment, when power is drawn from the battery system 100, a current is induced at terminal 106. Current Detector Switch 302 monitors the current flow against a threshold. When the threshold is detected, indicating a non-trivial load applied to the battery, the switch activates, providing power through power port 301 to activate the low power micro controller 306. This approach is particularly well suited to a battery application where the batteries are used intermittently. Under those conditions the micro controller would only be powered when the battery was actually in use. The micro controller 306 executes logic contained in onboard ROM 310 which controls its operation and is functionally described below. The state of the battery subsystem 100 is restored from nonvolatile storage 318, for example, flash memory, into RAM 312. This may include, for example, energy consumption since the last time the battery was charged, rated battery energy capacity and, usage history.

Time intervals can be measured with the assistance of on board interrupt controller 308, which is in an exemplary embodiment, configured to generate interrupts at regular intervals such as once a second. Counting these intervals can track the passage of time. On every Nth interval (e.g., 10 intervals), the change in battery 316 state can be calculated and state variables in RAM 312 can be updated. On every Mth interval, where M>=N, the state of the non-volatile display 102 is updated if the state of the battery 316 is calculated to have changed by a sufficient amount to warrant updating the display. When current once again drops below the threshold, the current detector switch 302 generates a signal on signal line 300 indicating to the micro controller 306 that the battery usage interval has ended. The signal is generated sufficiently ahead of loss of power to the microcontroller to allow the micro controller 306 to finalize the present calculation, update the display 102 if needed and update the nonvolatile memory with the new information.

In one alternate exemplary embodiment the time between Nth intervals is sufficient to allow the micro controller and other supporting electronics to enter a low power state conserving battery power. By adjusting N, the interrupt interval, a tradeoff can be made between accuracy of the results and power overhead for the measurement.

Calculating the change in the state of battery 316 can be based one or more measurements, including but not limited to time interval of the present power draw, electrical current measurements from the current measurement circuit 304, voltage measurement from the voltage measurement circuit 314 and temperature measurement from thermometer 303. Changes in temperature affect the efficiency of battery power transfer. These measurement circuits are illustrative. Depending on the implementation considerations such as battery chemistry, economic factors, and desired level of accuracy, some of these circuits may not be eliminated in a given implementation.

It is contemplated that FIG. 3 components such as micro controller 306 may be implemented in an exemplary embodiment using Application Specific Integrated Circuit (ASIC) technology. Through the use of ASIC technology further cost reductions will be realized.

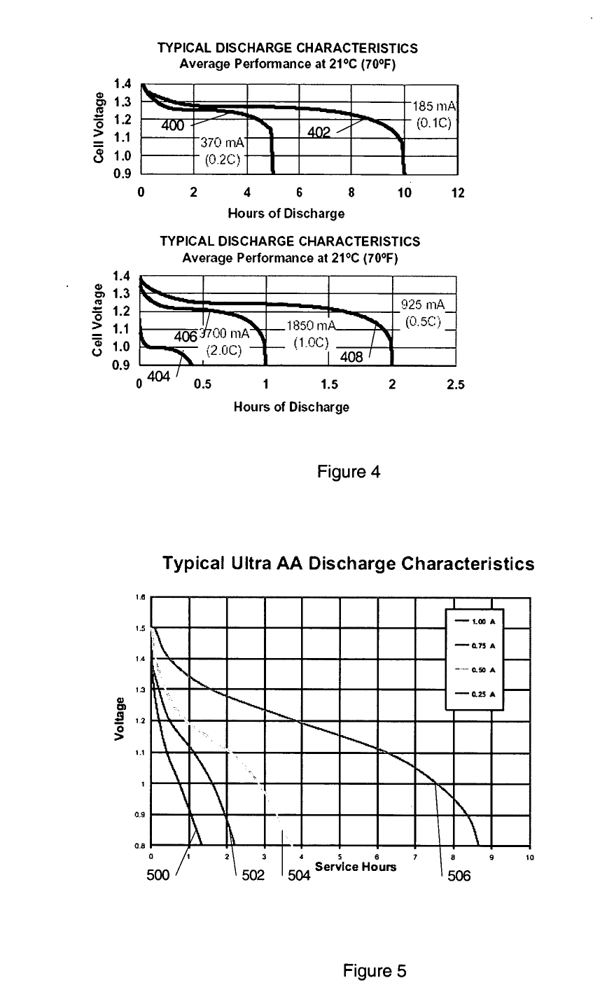

FIG. 4 illustrates the discharge characteristics for an Eveready No. NH15 NiMH battery which is rated at an average capacity of 1850 mAh down to 1.0 volts. For example, curve 400 illustrates the change in battery voltage over time when the NH15 is subjected to a current draw of 370 mA. At time 0 the NH15 will output 1.4 volts by hour 4 output voltage is reduced to approximately 1.22 volts and drops below 1 volt at 4.5 hours. For purposes of illustration 1 volt is used here to indicate the end of useful life. The true end of useful life of a battery is dependent on the voltage sensitivity of the application. In a similar manner the other curves 402, 404, 406, and 408 illustrate discharge characteristics at 185 mA, 3700 mA, 1850 mA, and 925 mA respectively.

Notice the extended period of time that the battery remains within 0.1 volts of 1.2 volts. Voltage level would not be a good predictor of remaining battery life with this type of battery.

FIG. 5 provides a similar illustration for the Duracell Ultra MX1500 AA Alkaline-Manganese Dioxide Battery (Alkaline). The format and type of information differs between these to battery types. It varies from manufacturer to manufacture and with battery chemistry as can be seen by comparing FIG. 5 with FIG. 4. However useful information can be gained by comparing these data. Curve 500 illustrates the MX1500 initially outputs 1.5 volts, however by approximately 0.7 hours the output voltage has dropped to 1 volt under a current draw of 1.0 A or 1000 mA. Curves 502, 504, and 506 display information for 750 mA, 500 mA and 250 mA respectively.

Notice that voltage change with battery life is much more pronounced with this battery. Voltage is a much better predictor of remaining life.

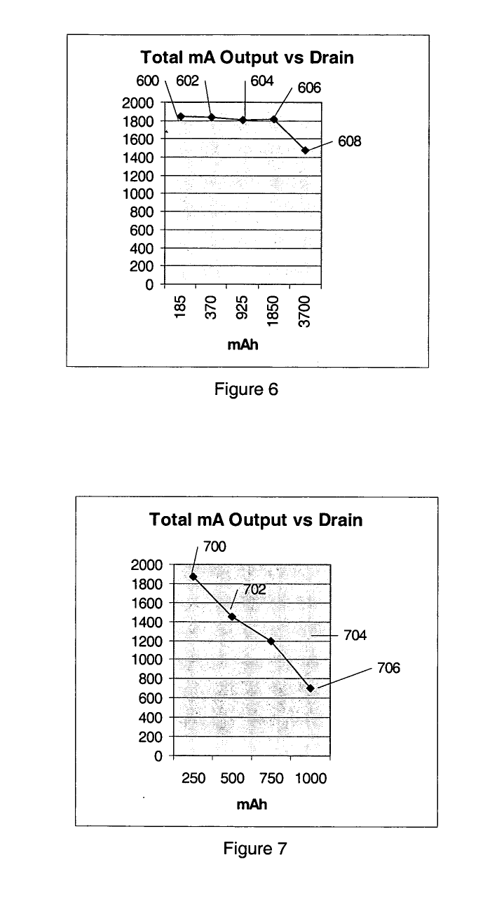

FIG. 6 and FIG. 7 are charts of available battery energy capacity derived from FIG. 4 Eveready No. NH15 NiMH and FIG. 5 Duracell Ultra MX1500 Alkaline-Manganese respectively. By way of illustration point 600 was created by reading the point were curve 402 in FIG. 4 crosses 1.0 Volt. This corresponds to 9.9 hours. By multiplying the time in hours by the 185 mA current load we reach a total available energy of 1831.5 for this battery under this load until is has discharged to an unusable level. Of course the usable level of a battery is subjective and will vary from one application to another. The same method was used to derive points 602, 604, 606, and 608 in FIG. 6 and points 700, 702, 704, and 706 in FIG. 7.

By analyzing FIG. 6 we see that, for this NiMH battery, the total available battery energy is not substantially affected by current drain up to and including point 606 which corresponds to a current drain equal to the rated capacity of the battery for one hour. Point 608 illustrates a current drain that exceeds the rated battery capacity, and we see a corresponding decrease in available battery energy. These observations will be useful when designing a method of computing the amount of available battery capacity remaining when given a history of current demand. One possible embodiment based upon this observation only requires measurement of current level and time interval. Multiplying current level by time interval yields the number of mAh consumed during the interval. Subtracting this from the total battery capacity would yield available capacity remaining.

Similarly, by analyzing FIG. 7 we see a very different pattern. The available battery energy capacity for this alkaline-manganese dioxide battery varies depending on current load. One embodiment for this battery is to maintain a chart derived from FIG. 7 which indicates the number of mA consumed per unit time over the range of likely current draws. This table will be maintained in ROM 310. For each current level and time interval an adjustment to the total remaining mA can be derived by looking up the current level and determining the corresponding mA value. This value will be multiplied by the time interval and the result will be the estimated mA used, which when subtracted from the total available mA for the battery yields remaining mA.

In an alternate embodiment the device would contain a clock (not shown) which would run continuously from the time the battery was manufactured or recharged. It could be used to estimate the amount of internal battery drain or the remaining shelf-life of the battery.

An additional factor to address with rechargeable batteries is the detection of battery recharge. In FIG. 3 battery 316 requires recharging when the energy becomes depleted. To recharge battery 316 a battery charger (not shown) would be connected to positive terminal 106 and negative terminal 104, and a current would be induced by the charger by providing a voltage across terminals 106 and 104 which is greater than the voltage provided by battery 316. An enhancement to voltage measurement circuit 314 can be used to detect voltage greater than the rated battery voltage, indicative of battery charger operation. A signal indicative of charger operation would be provided by voltage measurement circuit 314 to microcontroller 306, causing microcontroller 306 to reset the battery state in nonvolatile storage 318, RAM 312, and non-volatile display 102, to reflect the recharged state of the battery. This method is only illustrative; other methods of recharge detection are possible. Other battery technologies may require other recharge detection mechanisms. Economic and other factors may favor the use of the above-described method or an alternate method.

A further illustrative embodiment employs a micro-switch embedded in the battery casing which activates power to the micro-controller. This allows current to activate the micro-controller which then reads the battery parameters and estimates the amount of useful energy available. Various exemplary embodiments may supply current to the microcontroller only while the switch is activated; in others power to the microcontroller may be available for a pre-defined interval (controlled perhaps by the mechanics of the switch). In others the circuit closed by the switch may remain closed until the micro-controller completes its computations and display, and breaks the circuit.

Again, depending on design, the geometry, and cost constraints, various types of switches may be employed. On a AA battery, the switch might be located at the positive end of the battery below the elevated terminal and be activated by pressure from a fingernail. In other cases, it might be implemented as a thin pressure-sensitive switch located under the battery's skin.

Naturally such technology can be applied to any power storage device, including, again listing only a small subset of examples, non-rechargeable batteries, larger batteries (6 and 12-volt lead-acid batteries), capacitors, and other new, emerging power storage technologies, as well as those yet to be invented. Similarly the display technologies described herein reflect a sample of those which are presently currently viable and available, but is not intended to exclude those which are not mentioned, or which have not yet been invented.

FIG. 2 is an exemplary rendering of this further illustrative embodiment which includes a switched self-labeling storage device system. It includes an energy storage device 202, for example, an Alkaline-Manganese Dioxide battery such as for example a Duracell MX1500 AA battery. It contains a positive terminal 106, a negative terminal 104, and a display 204, such as for example a low power liquid crystal display. Further, it contains a micro switch 200 located on the side of the positive terminal 106. When the switch is depressed the remaining battery life is computed and displayed on display 204. A number of alternate locations for the micro switch are contemplated such as a soft squeeze button under the skin of the battery not shown.

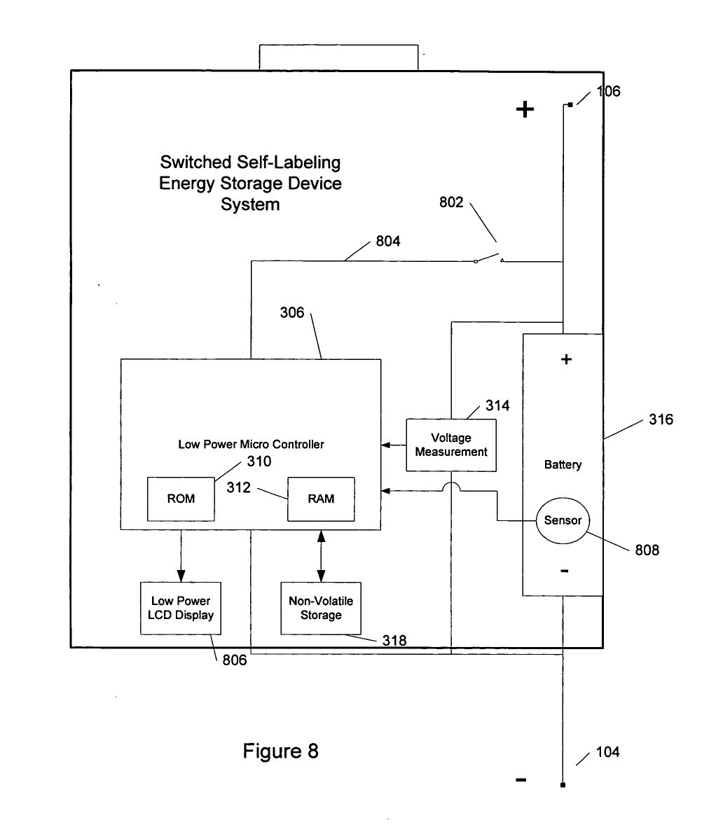

Turning now to FIG. 8, an exemplary block diagram of the components that comprise this exemplary embodiment is shown. Most of the components are in common with FIG. 3; and only the new components will be discussed. In place of the current detector switch 302 a momentary contact micro switch 802 is utilized. This enables current flow through 802 which provides manual activation of the device whereas the prior embodiment was activated automatically when current flow was detected. When the device is activated, the contents of RAM 312 are reloaded from Non-Volatile memory 318. Program instructions from ROM 310 control the testing and display of the results on low power LCD Display 806. The present output voltage is measured by Voltage Measurement device 314. Since this exemplary embodiment is for an Alkaline-Manganese Dioxide battery, voltage level may be used as a predictor of battery life. In one exemplary implementation, the present voltage is compared to the operational voltage range, such as 1.5 V-1.0 V and a percentage is calculated by the following steps:

1. The present voltage is determined from 314, Vp.

2. The usable voltage above the minimum is determined, Vu−Vp−Vmin.

3. If Vu <=0 battery is considered dead.

4. Percent Available=(Vu/(Vmax−Vmin))×100.

Additional characteristics of the battery may be determined by sensor 808, which may measure battery pH, or other chemical, electrical or mechanical properties.

The display 806 is updated with the results. If the display is small it may cycle through the data by for example displaying one set of information for a predetermined interval and then cycle to another set of information.

When the micro switch is released, the display 806 will go blank. In an alternate embodiment the display 806 would be non-volatile display such as an e-Ink display discussed above. In still a further embodiment the micro switch would only control the display 808 of data; however battery parameters would be continually updated.

In a still further embodiment, the system would include elements of the previous embodiments and, in addition, it would include one or more electrical contacts, for example, 206 and 208 shown, for example, in FIG. 2. These contacts could be used to communicate data from the energy storage units to for example, an external display such as found on the back of a digital camera. This would enable the state of batteries internal to a device to be externally viewable on a separate display or incorporated into a display that would otherwise be present on the device. In this embodiment, the display 204 may not be required.

One alternate embodiment of this device would include an electronic device for example a digital camera that had been modified to make use of these additional contacts 206 and 208.

A contemplated cost reduction measure of this modified electronic device is to design the modified device to accept only one of the self-labeling energy storage devices within the modified device such that it could act as a proxy for other non self-labeling energy storage devices. For example, in a digital camera that requires 4 AA batteries, one self-labeling device and 3 similar batteries but without the self-labeling capability could be used. The results from the self-labeling device could be multiplied by 4 to represent the state of all devices.

One further alternative to this embodiment is to use contacts such as 206 and 208 (more or less as needed) to gain access to internal sensors. This would enable a design where the electronics and the display could be removed from the self-labeling device and placed in a host device external to the batteries. Thus reducing the cost of the for example batteries.

A still further exemplary embodiment removes the components from the self-labeling energy storage device and places them in a compact frame that can be attached to a standard, for example, battery. This would permit any battery to be converted into a self-labeling storage device. One severe design constraint is that the resulting combined unit, including the battery and the self-labeling frame must be of a size to allow insertion into a high percentage of electronic devices. For example, the battery with frame attached should be able to fit within many digital cameras. It is recognized that this combined solution will not work with all devices, and the tolerances on many devices would not permit the extra element.

One exemplary solution to this issue would be to have batteries manufactured with an indentation sufficient to allow the frame to be attached and for the combined size to be within the size of a standard battery.

The block diagrams in this specification show discrete components, which are shown for illustrative purposes only. However, it is well known to those skilled in the art that cost and power savings can be achieved by reducing this invention to one or more integrated circuits. Similarly, simplifying and cost reducing the design by eliminating components such as the thermometer 303, nonvolatile storage 318, and one or more of the sensing devices such as the current measurement 304 or the voltage measurement 314 are contemplated.

Some of these embodiments can be best implemented by battery manufacturers. This is especially an issue where the components are integrated within the batteries with a common form factor such as AA, C, D, cells, where most applications depend on the standard size. Battery manufacturers have access to much more detailed specifications for their products. This will enable the use of, for example, pH sensor 808 where the data might not be easily available to 3^{rd} party manufacturers.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An energy storage device for providing energy and sized to be placed in a battery compartment of any one of a plurality of electrical devices comprising processing circuitry for determining the amount of available energy, and a display operatively coupled to said processing circuitry to provide an indication of available energy.

2. An energy storage device in accordance with claim 1, wherein said processing circuitry is a digital-processor.

3. An energy storage device in accordance with claim 1, wherein the display does not requires a constant source of power to maintain the display.

4. An energy storage device in accordance with claim 3, wherein the display device uses a Bi-Stable Zenithal display;

5. An energy storage device in accordance with claim 3, wherein the display uses e-ink technology

6. An energy storage device in accordance with claim 3, wherein the display uses electrostatic technology.

7. An energy storage device in accordance with claim 1, further including a switch to activate the processing circuitry.

8. An energy storage device in accordance with claim 1, wherein the device is compatible with AA batteries.

9. An energy storage device in accordance with claim 1, wherein the device is compatible with AAA batteries.

10. An energy storage device in accordance with claim 1, wherein the device is compatible with vehicle batteries.

11. An energy storage device in accordance with claim 1, wherein the device is compatible with NiCad batteries.

12. An energy storage device in accordance with claim 1, wherein the device is compatible with Li-ion batteries.

13. An energy storage device in accordance with claim 1, wherein the device is used in a digital camera.

14. An energy storage device in accordance with claim 1, wherein the device is used in an electronic appliance selected from the group consisting of media recorders, media players, illumination devices, computers, data memory devices, location sensing devices, broadcast recorders, broadcast players, communication devices, and computer peripheral devices.

15. An energy storage device in accordance with claim 1, wherein the processing circuitry determines an indication of at least one of the following:
anticipated battery life remaining,
amount of power remaining,
amount of usage time remaining

16. An energy storage device in accordance with claim 1, wherein at least one of the following indicators is displayed on said display:
anticipated battery life remaining
amount of power remaining
amount of usage time remaining.

17. An energy storage device in accordance with claim 1, wherein at least one of the following aspects of the battery are measured:
voltage
impedance
resistance
temperature
capacitance
chemical properties e.g. pH, alkalinity, presence and degree of trace compounds.

18. An energy storage device in accordance with claim 1, further including a digital memory whereby the history of aspects of the battery's state can be recorded.

19. An energy storage device in accordance with claim 18, wherein at last part of the recorded historical information is used as in the computation of the indication of at least one of the battery's projected life, anticipated time until exhaustion of current charge or other event, anticipated power remaining.

20. An energy storage device in accordance with claim 18, wherein at last some of the said digital memory does not require power to maintain data in memory.

21. A rechargeable energy storage device for providing energy and sized to be placed in a battery compartment of any one of a plurality of electrical devices comprising recharge detection circuitry for detecting that the energy storage device is being recharged, processing circuitry for controlling the storage of updated battery state information in response to the detection that the storage device is being recharged, and a display to provide an indication of the recharged state of the energy device.

22. A rechargeable energy storage device in accordance with claim 21, wherein said recharge detection circuitry includes a voltage measurement circuit.

23. An energy storage device in accordance with claim 21, wherein said processing circuitry is a digital-processor.

24. An energy storage device in accordance with claim 21, wherein the display does not requires a constant source of power to maintain the display.

25. An energy storage device for providing energy and sized to be placed in a battery compartment of any one of a plurality of electrical devices comprising processing circuitry for determining the state of said energy storage device, and a display operatively coupled to said processing circuitry to provide an indication of said state of said energy storage device.

26. An energy storage device in accordance with claim 25, wherein said processing circuitry is a digital-processor.

27. An energy storage device in accordance with claim 25, wherein the display does not requires a constant source of power to maintain the display.

28. An energy storage device in accordance with claim 27, wherein the display device uses a Bi-Stable Zenithal display;

29. An energy storage device in accordance with claim 27, wherein the display uses e-ink technology

30. An energy storage device in accordance with claim 25, wherein at least one of the following states is displayed on said display:
anticipated battery life remaining
amount of power remaining
amount of usage time remaining.
